(19) United States
(12) Patent Application Publication
(10) Pub. No.: US 2026/0061980 A1
(43) Pub. Date: Mar. 5, 2026

(54) PUMP KIT FOR SPRING APPLIED HYDRAULIC RELEASE BRAKE

(71) Applicant: Ausco Products, Inc., Benton Harbor, MI (US)

(72) Inventors: Brian P. Dennis, Kalamazoo, MI (US); Donald Schmidt, Benton Harbor, MI (US); Evan Whitney, Buchanan, MI (US); Peter J. Pozivilko, St. Joseph, MI (US)

(21) Appl. No.: 19/312,962

(22) Filed: Aug. 28, 2025

Related U.S. Application Data
(60) Provisional application No. 63/688,478, filed on Aug. 29, 2024.
(60) Provisional application No. 63/754,833, filed on Feb. 6, 2025.

(51) Int. Cl. B60T 13/14; B60T 13/22; B60T 13/68

(52) U.S. Cl. CPC B60T 13/148; B60T 13/22; B60T 13/686

(57) ABSTRACT

A pump kit includes a motor assembly including a first spline as an output, the first spline being coupled with a second spline of an actuator shaft; the actuator shaft including an extension with male threading threaded with an inner female threading of a piston within a through hole of the piston; and the piston including an external slot with a component having an at least partial spherical surface sitting therein, the component having the at least partial spherical surface also being partly positioned within a hole within an outside of a housing; where the slot, the component having the at least partial spherical surface, and the hole in the housing are configured to prevent the piston from rotating in an operational configuration, such that the operational configuration instead includes the piston moving toward a fluid cavity within the housing.

### CROSS REFERENCE TO RELATED APPLICATIONS

This application claims the benefit of U.S. Provisional Application No. 63/688,478, filed Aug. 29, 2024, and claims the benefit of U.S. Provisional Application No. 63/754,833, filed Feb. 6, 2025, which are incorporated herein by reference.

### TECHNICAL FIELD

One or more embodiments of this invention relate to a pump kit for a spring applied hydraulic release brake.

### BACKGROUND

Spring applied hydraulic release (SAHR) brakes default to the engaged brake position. Thus, SAHR brakes only release when hydraulic pressure is applied, which serves as the normal driving condition. When the hydraulic pressure is released, the default position includes springs engaging the brake. This ensures the braking function automatically happens at certain times, such as when the vehicle is shut down. As other examples, the default braking condition may occur when the vehicle user opens a door or unbuckles a seat belt, which can be said to create an automatic parking and emergency brake. This automatic default braking nature of SAHR brakes can be crucial to safety and these brakes are therefore common on mining, construction, and agricultural vehicles.

Most SAHR brakes are installed on vehicles which already have power hydraulic systems, such as farm tractors, dozers, and loaders. The SAHR brakes for these vehicles can therefore be connected to the existing hydraulic circuits, which can include the addition of a parking brake valve. However, some vehicles which do not have an existing hydraulic system will benefit from automatic SAHR braking, such as for safety or compliance with regulations. For these vehicles without an existing hydraulic system, an electric-over-hydraulic pump kit can be utilized to provide the hydraulic pressure needed to support SAHR braking.

U.S. Pat. No. 9,592,801 discloses a parking brake system which is suitable for use with a small mining vehicle that does not have a hydraulic system (i.e., as an electric-over-hydraulic pump kit). U.S. '801 discloses an electric motor driving a pump used in concert with a dump valve (e.g., a solenoid dump valve) to create hydraulic pressure to release or engage a brake (e.g., SAHR brake). The solenoid valve is a normally open device, though when current is present in the coil, the valve is closed. The solenoid valve opens or closes a path from the brake line to a fluid tank, the fluid tank being at atmospheric pressure, i.e., zero pressure. The solenoid valve must be closed to allow pressure to build in the brake line. When the solenoid valve is open, a path is open to the tank, so the brake line pressure will drop to zero. For normal driving, the solenoid is commanded to close, allowing pressure to build. The motor is engaged, turning the pump to create flow and pressure in the brake line.

U.S. '801 discloses a programmable logic controller (PLC) reading a pressure transducer placed on the brake line. The PLC uses the pressure reading to determine when the pressure is high enough, in order to turn off the motor at the suitable pressure. Though the motor is turned off, the current to the solenoid coil remains on, which keeps the valve closed. This causes the pressure to remain in the brake line after the motor is turned off, which keeps the brake released. When the PLC commands the brake to engage, power to the solenoid valve is cut, which causes the solenoid valve to open. This causes pressure to be dumped to the tank, dropping the brake line pressure to zero and causing the brake to engage.

Other conventional electric-over-hydraulic pump systems utilize mechanical switching and tend to lack programmability and tend to be less reliable. For example, switches are mechanical and therefore tend to be more vulnerable to corrosion and wear. Conventional electric-over-hydraulic pump systems tend to be very large and cumbersome in design. This large size leads to difficult assembly on smaller vehicles, such as on small golf cart size vehicles.

Another conventional solution for vehicles without a hydraulic system relies on the use of a hand pump. This solution may be particularly utilized with very small vehicles. Rather than using a pump and a motor, a hand pump relies on a manual pump-up cylinder. Generally, the vehicle driver will manually turn a knob to close the path to tank and then will pump on the handle to create flow and pressure, manually doing the job of an electric motor. In most cases, to engage the brake, the operator needs to turn the knob to release pressure manually in order to engage the brake. And while the typical conventional hand pump has an internal relief valve that limits the pressure, if this relief valve is not set to the correct pressure, there is a potential for over-pressurization. Any such over-pressurization can damage the brake and can therefore create a safety issue. Also, certain regulations may require a panic button within reach of the driver in order to engage the brake quickly in an emergency; hand pumps generally do not provide this capability.

There remains a need in the art for an improved pump kit for a spring applied hydraulic release brake.

### DISCLOSURE OF THE INVENTION

An object of one aspect of the present invention is a pump kit for a spring applied hydraulic release brake which is capable of fitting onto relatively small vehicles.

An object of another aspect of the present invention is a pump kit which is of relatively lower cost while also providing suitable levels of safety, reliability, and operational convenience.

These and other objects of the present invention, as well as the advantages thereof over existing prior art forms, which will become apparent from the description to follow, are accomplished by the improvements hereinafter described and claimed.

In general, a pump kit for a spring applied hydraulic release brake includes a motor assembly including a first spline as an output, the first spline being coupled with a second spline of an actuator shaft; the actuator shaft including an extension with male threading threaded with an inner female threading of a piston within a through hole of the piston; and the piston including an external slot with a component having an at least partial curved surface sitting therein, the component having the at least partial curved surface also being partly positioned within a hole within an outside of a housing; where the slot, the component having the at least partial curved surface, and the hole in the housing are configured to prevent the piston from rotating in an operational configuration, such that the operational configuration instead includes the piston moving toward a fluid cavity within the housing.

In accordance with another aspect of the invention, a method of controlling brake line pressure via a pump kit includes steps of instructing, via a controller, a current to be applied to a motor and a solenoid valve to thereby close a path between brake outlet ports of the pump kit and tank ports of the pump kit; allowing the motor to urge an actuator shaft to turn, where the actuator shaft is threaded into a piston, where the piston includes a slot with a component having an at least partial curved surface sitting therein, with the component having the at least partial curved surface also being partly positioned within a hole within an outside of a housing of the pump kit; and urging the piston to move toward a fluid cavity within the housing based on the slot, the component having the at least partial spherical surface, and the hole in the housing being configured to prevent the piston from rotating in an operational configuration.

### BRIEF DESCRIPTION OF THE DRAWINGS

FIG. 1 is a perspective view of a pump kit according to one or more embodiments of the present invention.

FIG. 2 is a top view of the pump kit of FIG. 1.

FIG. 3 is a sectional view taken substantially along line A-A of FIG. 2.

FIG. 4 is a sectional view of a manifold of the pump kit of FIG. 1.

FIG. 5 is a close-up view of a spring assembly of the pump kit of FIG. 1.

FIG. 6 is a perspective view of an alternative pump kit according to one or more embodiments of the present invention.

FIG. 7 is a top view of the pump kit of FIG. 6.

FIG. 8 is a sectional view taken substantially along line A-A of FIG. 7.

FIG. 9 is an alternative perspective view of the pump kit of FIG. 6.

### DETAILED DESCRIPTION

One or more embodiments of the present invention relate to a pump kit for a spring applied hydraulic release (SAHR) brake. SAHR brakes default to the engaged brake position and only release when hydraulic pressure is applied. Certain vehicles which can benefit from SAHR brakes do not have an existing hydraulic system. Advantageously, the pump kit of embodiments of the present invention can be utilized to provide the hydraulic pressure needed to support SAHR braking for vehicles that do not have an existing hydraulic system. As further discussed herein, the pump kit is an assembly which includes an electric motor driving a screw that pushes a piston to displace oil to thereby release a corresponding SAHR brake. The corresponding SAHR brake can be a caliper brake or a multi-disc brake.

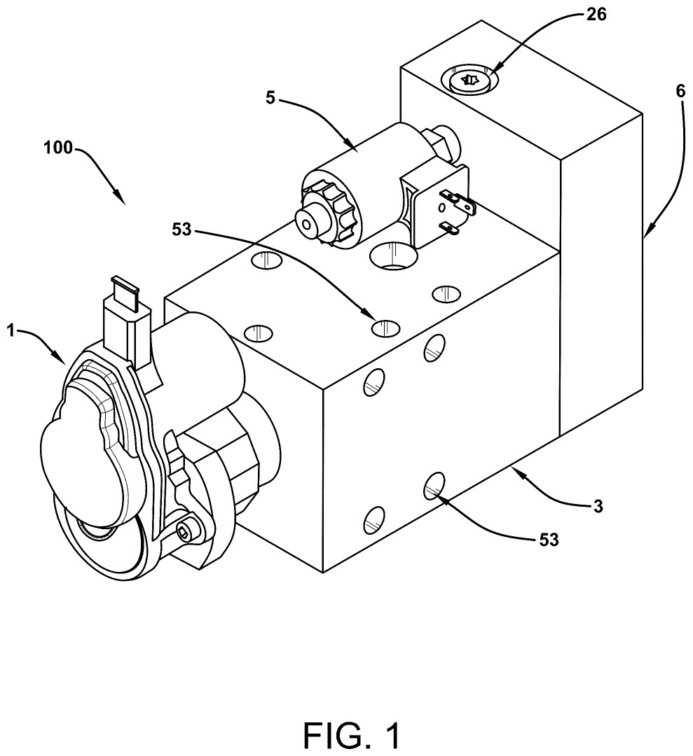

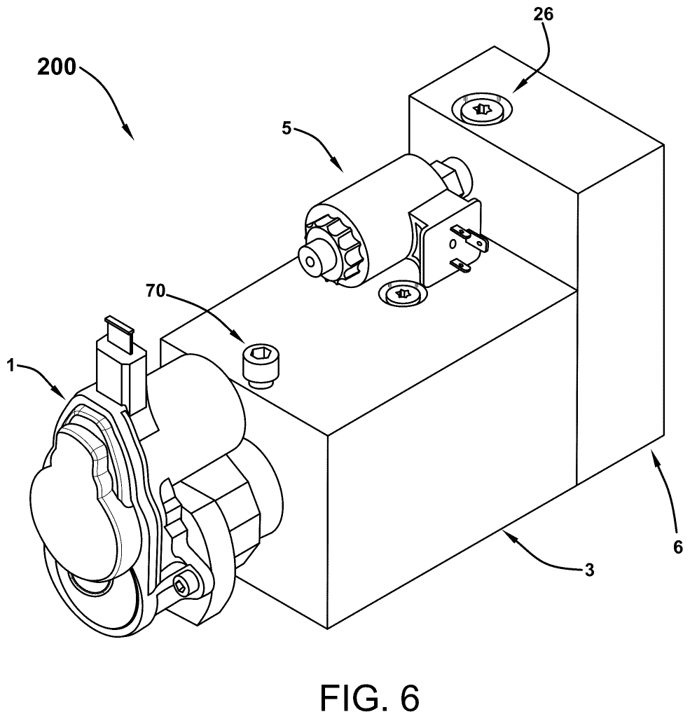

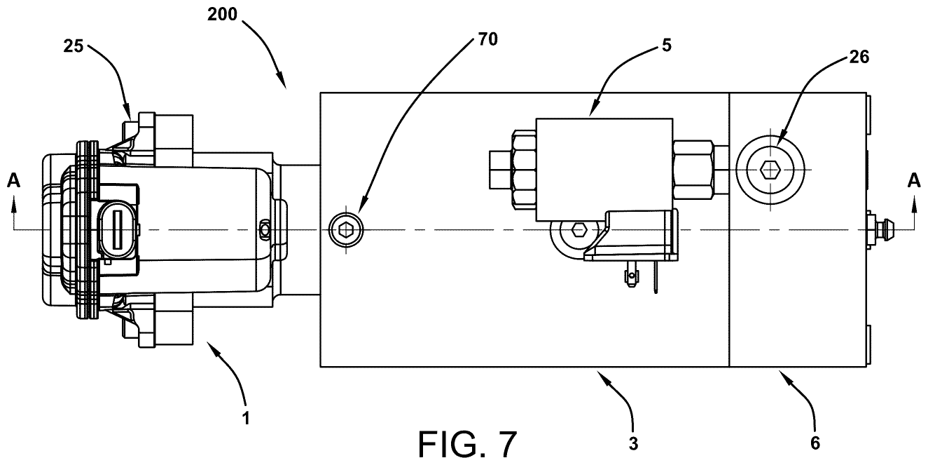

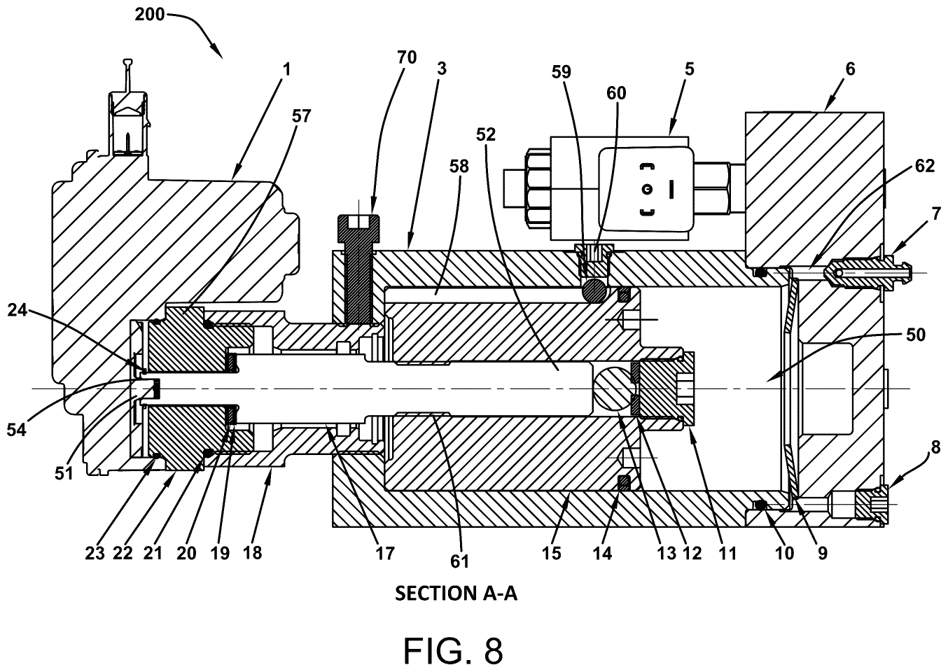

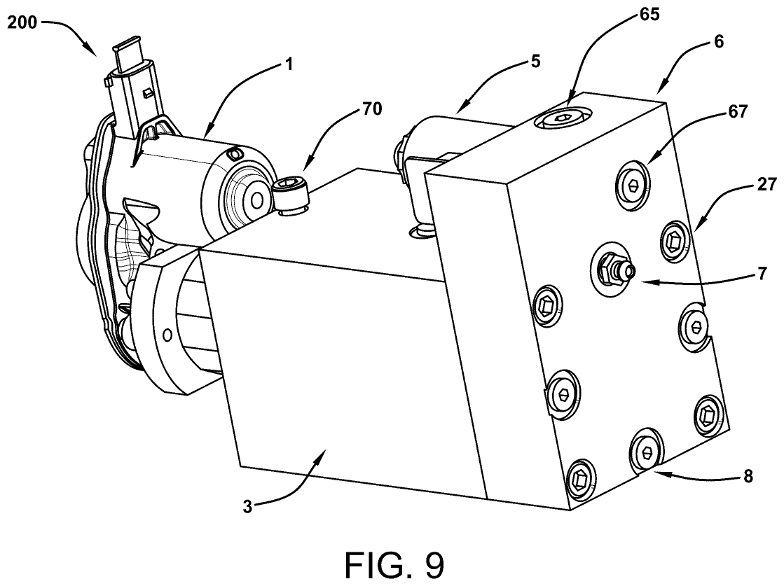

With reference to the Figures (FIGS. 1 to 9), a first pump kit according to one or more embodiments of the present invention is indicated by the numeral 100 in FIGS. 1 to 5 and a second pump kit according to one or more embodiments of the present invention is indicated by the numeral 200 in FIGS. 6 to 9. In accord with the Figures and the following description, it should be readily appreciated that certain components and features of first pump kit 100 and second pump kit 200 are similar. For example, the components shown with manifold 6 in FIG. 9 for pump kit 200, such as socket head cap screws 27, also apply to pump kit 100. The following description will generally note where components and features are different. The pump kit 100, 200, which may also be referred to as electric-over-hydraulic pump kit 100, 200 or assembly 100, 200, may be particularly suitable for use with a spring applied hydraulic release (SAHR) brake (not shown). Though not shown in the Figures, assembly 100, 200 might be contained within an enclosure in one or more embodiments, which enclosure might be employed to prevent damage to assembly 100, 200.

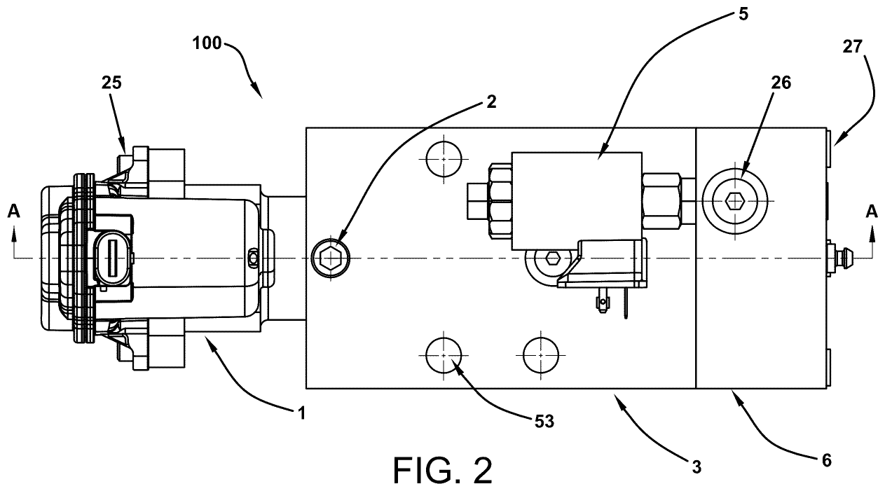

Pump kit 100 includes a motor assembly 1 secured with a housing 18 carrying a piston 15 with an actuator shaft 17 therewithin. A portion of actuator shaft 17 is contained within housing 18 and a relative left end of piston 15 is adapted to contact a relative right end of housing 18 during operation, as will be discussed further herein. Piston 15, a portion of actuator shaft 17, and a portion of housing 18 are contained within a cylinder housing 3, which may also be referred to as housing 3. Housing 3 is shown with a generally rectangular shape though other shapes are suitable. A relative right end of cylinder housing 3 is contained within and secured within a manifold 6, which right end of cylinder housing 3 is sealed with an O-ring 10. Manifold 6 is attached to cylinder housing 3 by four socket head cap screws 27 (FIG. 2, and FIG. 9 relative to pump kit 200). Cylinder housing 3 is shown with through holes 53 for mounting pump kit 100. Pump kit 100 specifically includes four vertical through holes 53 and four horizontal through holes 53. Other numbers of through holes 53 or other locations are possible, including only sloped orientation, only horizontal, only vertical, or combinations of sloped with horizontal and/or vertical. Pump kit 200 is shown without through holes 53, though pump kit 200 can also employ through holes 53. Pump kit 100, 200 can be mounted with a technique other than through holes, such as being strapped in place or an enclosure being provided with the pump kit with the enclosure being mounted.

As will be further described, an end of housing 18 is secured with an end plate 22. Housing 18 and end plate 22 can be made from aluminum and may be hard coat anodized for wear and corrosion resistance. Housing 18 and end plate 22 can have a dodecagon shaped perimeter, or other shape with flat surfaces. Other suitable shapes for the flat surface include other polygons (e.g., decagons, hexagons, octagons), and two flat surfaces between two rounded surfaces. Housing 18 is internally threaded on the relative left side to accept male threads from end plate 22. Housing 18 also includes a through bore to allow actuator shaft 17 to pass through the housing 18 unimpeded. On the relative right side of housing 18, there are internal features including two grooves and a counterbore.

Housing 18 is threaded into cylinder housing 3 with an external thread formed on housing 18. This configuration allows motor 1 to be rotated into a convenient orientation for the end user. The dodecagon or other flat surface perimeter can be used to allow a tool, such as an adjustable wrench, to rotate housing 18. The dodecagon or other flat shape perimeter allows the perimeter shape to be formed by extrusion, negating the need for extra machining.

Socket head set screw 2 is shown as a standard set screw, which can include a soft material tip, such as nylon, bronze, or brass. Once the ideal orientation of housing 18 and motor 1 are established, the set screw 2 drives the soft material tip into the external thread of housing 18. This locks housing 18 from further rotation. As shown in second pump kit 200, it is possible to use a socket head cap screw 70 in place of socket head set screw 2. Where the bolt 70 does not include a nylon or similar soft tip, a separate part, such as a slug of soft aluminum or nylon or similar soft material would have to be dropped in the hole to prevent the socket head cap screw 70 from crushing the aluminum threads of housing 18.

As will be further described, motor assembly 1 acts on the actuator shaft 17, which acts on the piston 15 to displace oil within a fluid cavity 50. The displaced oil causes pressure to build within a brake line (not shown), which results in releasing the corresponding SAHR brake from the default braking configuration. Actuator shaft 17 and piston 15 can be made from steel and may be heat treated to prevent wear, particularly on the threaded sections. The size of the piston 15 can be designed to create different pressure capacities. Said another way, different sized pistons 15 can create different pressure capacities. For example, pump kit 100 and pump kit 200 are shown with somewhat different sized pistons 15. By employing a smaller piston, fluid volume displacement capacity goes down but pressure goes up. The skilled person will understand the adjustment of piston sizes, piston stroke, actuator volumes, and line pressures to alter pressure and volumetric displacement.

Motor assembly 1, which may be referred to as motor 1 or electric motor 1, includes an electric actuator including a motor with a gear reduction (not seen). While certain details of motor 1 are given here, the skilled person will understand other details relative to the design and operation of motor 1. The gear reduction is used to amplify torque, allowing a relatively small and high-speed electric motor to create a much higher output torque at lower speed. The output from electric motor 1 is a small male spline 51 which interacts with actuator shaft 17. Other suitable motors for electric motor 1 may utilize a female spline as an output, with the corresponding end of actuator shaft 17 being modified accordingly for these motors. Male spline 51 may therefore be referred to simply as spline 51.

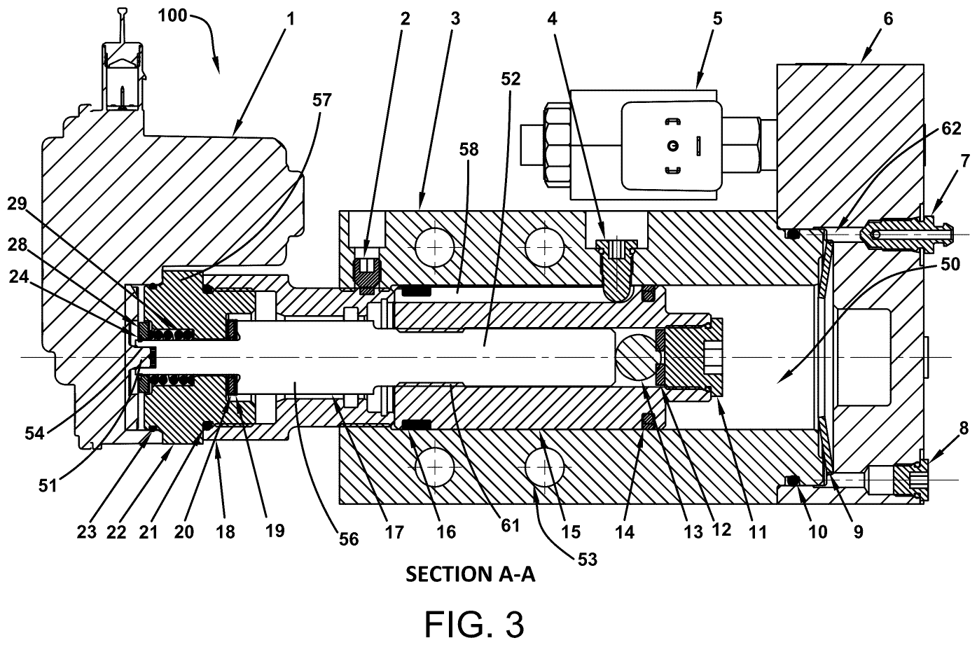

Actuator shaft 17 has an extension 52 extending away from motor 1 (i.e., on the right-hand end in the view of FIG. 3) which acts as a male screw threading relative to an inner female threading of piston 15. On the side near motor 1 (i.e., left-hand end of FIG. 3), a female spline 54 of actuator shaft 17 couples actuator shaft 17 to male spline 51 on the output side of motor 1. A retaining ring 24 holds spline 54 of actuator shaft 17 onto the spline 51, which may be referred to as output shaft 51, of motor 1 to prevent them from decoupling. Retaining ring 24 is positioned in a groove on actuator 17 (i.e., left-hand end of FIG. 3) ensuring that the splines 51, 54 from actuator shaft 17 and motor 1 remain engaged and do not separate.

Spring retainer 28 and compression spring 29 are also utilized to prevent retaining ring 24 from popping out of the groove in actuator 17 during retraction of the piston 15. Spring retainer 28 is a hardened steel washer with a counterbore on the left side. The hardening can be employed to prevent wear during operation. Both spring retainer 28 and compression spring 29 are positioned in their respective counterbores on the relative left side of an end plate 22.

Retaining ring 24 would otherwise tend to pop out of the groove if it expands. The counterbore of spring retainer 28 encompasses retaining ring 24 with minimal clearance and prevents expansion of retaining ring 24. This prevents the retaining ring 24 from popping out of the groove. Compression spring 29 keeps spring retainer 28 in constant contact with the retaining ring 24 during operation to ensure spring retainer 28 is always in position to prevent retaining ring 24 from expanding.

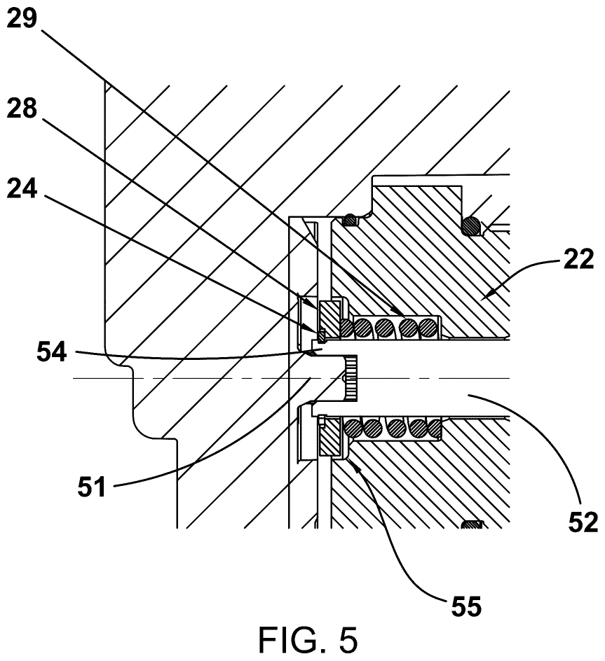

To assemble the retaining ring 24 in position, retaining ring 24 must be expanded. Spring retainer 28 is designed to prevent that from happening, so retaining ring 24 cannot be assembled with spring retainer 28 in its operational position encompassing retaining ring 24. A small gap 55 (FIG. 5) can be seen between spring retainer 28 and end plate 22. During assembly, spring retainer 28 is pushed to the relative right. This compresses compression spring 29, which allows assembly of retaining ring 24 into the groove. Once assembled, the force pushing spring retainer 28 to the relative right is removed, and compression spring 29 pushes spring retainer 28 into operational position, such that it encompasses retaining ring 24.

Actuator shaft 17 includes a flange 56 formed nearer to the motor side of actuator shaft 17. The flange 56 rests on a combination of a pair of thrust washers 19 and needle thrust bearing 20. Needle thrust bearing 20 is trapped between thrust washers 19, which allows the rollers of needle thrust bearing 20 to roll on the hardened surfaces of thrust washers 19. In absence of the hardened surfaces, the rollers of needle thrust bearing 20 can otherwise wear and damage the mating parts. Other bearing materials will also be suitable in place of the combination of thrust washers 19 and needle thrust bearing 20, such as a metal (e.g., bronze) bushing or a plastic bearing made of a suitable plastic material.

End plate 22 is sandwiched between motor assembly 1 and housing 18 by particular way of a radial outward extension 57. That is, respective ends of radial outward extension 57 contact motor assembly 1 and housing 18. End plate 22 is secured with motor 1 and housing 18 via a plurality of fasteners 25, which can be screws such as socket head cap screws 25 (FIG. 2). An inner portion or counter bore of end plate 22 serves as a reaction surface for washers 19 and needle thrust bearing 20. That is, the combination of the thrust washers 19 and the needle thrust bearing 20 are positioned between the flange 56 and the inner portion of the end plate 22. End plate 22 can be used in conjunction with O-rings 21, 23, which serve to seal end plate 22 from housing 18 and motor 1, respectively. The seal from O-rings 21, 23 serves to prevent water or other contaminants from entering motor 1, actuator shaft 17, and the surrounding mechanism, which tends to prevent corrosion and other damage.

As mentioned above, piston 15 contains an inner female thread that mates to the threaded extension 52 of actuator shaft 17 at a threading 61. At least one slot 58 is formed on the outside diameter of piston 15. Slot 58 is visible in FIG. 3 (i.e., section A-A) at the top of the piston 15. A wear ring 16 is employed outside of piston 15 to assist with preventing side loading and potential damage. Wear ring 16 can be formed from nylon, though other bearing materials such as bronze or other plastics may be suitable.

During operation, it is necessary to prevent rotation of piston 15 when actuator shaft 17 is rotating, and when the threads of piston 15 and actuator shaft 17 are causing piston 15 to move in or out. In pump kit 100, an anti-rotation plug 4 is threaded into cylinder housing 3. The nose of anti-rotation plug 4 is formed in a partial spherical shape, which can be made of steel or other suitable metal or material, and engages the slot 58 in piston 15. Said another way, plug 4 includes a partial spherical surface. The partial spherical surface can also be another suitable curved surface. The top of the plug 4 can be an SAE-4 O-ring boss to seal the hole in cylinder housing 3. In second pump kit 200, a ball 59, which can be a steel ball or other suitable material, is dropped into a hole formed in cylinder housing 3 to engage the slot 58 in piston 15. A hex socket plug 60 can be threaded into the top of the hole formed in cylinder housing 3 to keep ball 59 in position and to seal the hole in cylinder housing 3. It should be readily appreciated that ball 59 includes a spherical surface. For both pump kits 100, 200, the at least partially spherically shaped object sitting in the slot 58 of piston 15 prevents rotation of piston 15 when actuator shaft 17 is rotating.

Piston 15 contains a hole on the relative righthand end, which hole can be provided with threading via a boss, such as an M22, ISO 6149 O-ring boss. The boss receives a plug 11, which can be a hex socket plug 11 such as an M22 ISO 6149 O-ring plug 11. Hex socket plug 11 seals the hole. The hole on the end of the piston 15 can be utilized for ease of manufacturing. A blind hole in lieu of hex socket plug 11 would also be possible. The hole on the relative righthand end of piston 15 goes most of the way through piston 15 up to threading 61. Threading 61 includes internal thread of piston 15 threaded with external threading of actuator shaft 17. Threading 61 is partial threading and does not extend all the way about piston 15 or actuator shaft 17. This relatively shorter threading 61 can be easier to manufacture, and the skilled person will appreciate that full thread strength can be achieved with approximately five full threads. In other embodiments, threading 61 includes nine full threads. The hole in piston 15 provides clearance for the male threads of actuator shaft 17, once the threaded section of actuator shaft 17 moves beyond the threaded section of piston 15. Piston 15 further includes a seal 14 which is on the outside of piston 15. Seal 14 serves to seal piston 15 to cylinder housing 3. An exemplary seal 14 is a polytetrafluoroethylene (PTFE) slide ring with an O-ring energizer. Other seal types include O-rings and those of the type available under the trade name PolyPak® seal.

As mentioned above, a fluid cavity 50 exists, which is specifically formed by piston 15, cylinder housing 3, and manifold 6. Fluid cavity 50, which may also be referred to as pressure cavity 50, is just to the right of piston 15 in the configuration of FIG. 3. Fluid cavity 50 can be both filled with oil and bled through any one of through holes 62, which may also be referred to as outlet ports 62 or channels 62, where four through holes 62 are shown in pump kits 100, 200. Of the four holes 62 in manifold 6, which will generally be of the same type, three holes 62 are plugged by hex socket plugs 8 and the fourth hole 62 is plugged by bleeder 7. The outlet port 62 with the bleeder 7, which may be referred to as a bleeder screw 7, will be particularly used for filling and draining pressure cavity 50, though the particular outlet port 62 which includes the bleeder 7 can be adjusted. All four outlet ports 62 are shown with SAE-4 O-ring bosses, though other port sizes and types are possible. All four outlet ports 62 are in hydraulic communication with one another, as well as with the pressure cavity 50. As mentioned above, any of these outlet ports 62 can be used to attach a brake line and a pressure sensor. The attached outlet port 62 serves as the output to the brake line. Once the desired location is established, the plug 8 for that location is removed, and a brake line is assembled into that outlet port 62. The configuration with a plurality of outlet ports 62, such as the four shown, allows for multiple options for orientation and mounting. Should a user wish to rotate the entire pump kit 100, 200 about the axis of piston 15 to a different orientation for mounting flexibility purposes, bleeder 7 can be moved to whichever hole is at the relative top. The bleeder 7 must always be at the relative top to allow air to escape.

A pressure sensor (not shown) should be hydraulically connected to the pressure cavity 50 and therefore to the associated brake line and brake attached with pump kit 100, 200. This can be done multiple ways. The pressure sensor may be directly connected to one of the outlet ports 62. If the selected pressure sensor does not have an SAE-4 O-ring boss connection, the pressure sensor may still be directly connected by use of an adapter. The pressure sensor may also be connected remotely either on a separate outlet port with a separate and isolated line or by using a tee fitting on the brake line itself. Finally, the pressure sensor could be directly connected to the brake. The choice of where to place the pressure sensor can depend on convenience from a wiring and plumbing standpoint. The pressure sensor can be a pressure transducer or a solid state pressure switch. A mechanical pressure switch is also possible, though this could suffer from reliability problems in relatively harsher environments. The output from the pressure sensor will be read by a controller (not shown).

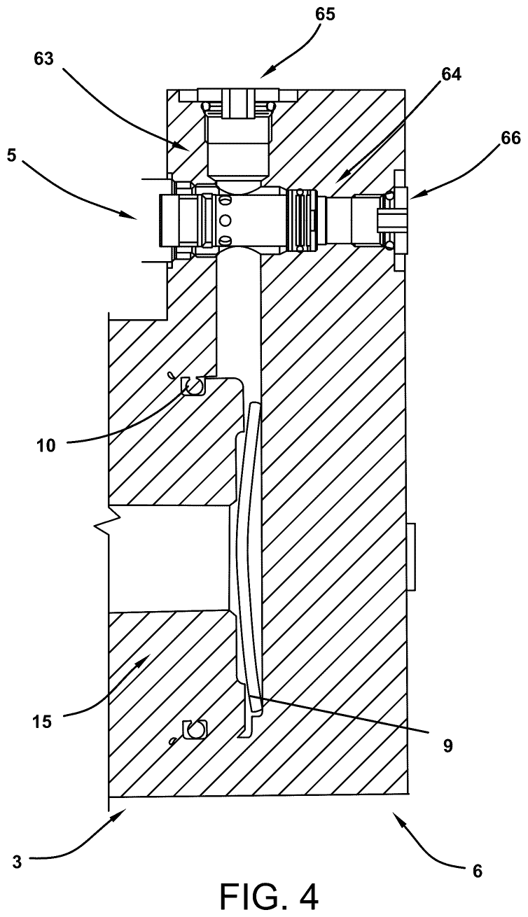

Two tank ports, a top tank port 63 and a side tank port 64 (FIG. 4), are in hydraulic communication with one another. Top tank port 63 is shown with an SAE-6 O-ring boss and corresponding hex socket plug 65, and side tank port 64 is shown with an SAE-4 O-ring boss and corresponding hex socket plug 67, though other sizes are possible. At least one of the tank ports 63, 64 will be attached to a reservoir (not shown), which may be directly attached to manifold 6 or may be remotely located. The reservoir could also be formed as part of manifold 6. The reservoir will be vented to atmospheric pressure, and therefore the two tank ports 63, 64 will likewise be open to atmosphere.

A solenoid valve 5 is threaded and sealed into a mating port in manifold 6. The mating port in manifold 6, which can also be referred to as a solenoid port, can be formed according to specifications dictated by the solenoid valve manufacturer. Different suitable solenoid valves might be utilized which would include employing a solenoid port to match such different solenoid valve. The solenoid port is in fluid communication with both the pressure cavity 50 and the tank ports 63, 64. Details of solenoid valve 5 will be generally known to the skilled person and an exemplary solenoid valve 5 is one sold under the model DTBFMHN from Sun Hydraulics. Alternate solenoid valves are also suitable.

Solenoid valve 5 should be of the normally open and direct acting type. A pilot operated valve could be possible, though using a pilot operated valve would require a relief valve on the brake line to ensure that excess pressure is vented to tank to prevent a “no brake” event should excess pressure lock the valve in the shut position. A direct acting valve does not suffer from this potential problem, since high pressure will simply overcome a direct acting valve causing it to open, if it is over-pressurized. Solenoid valve 5 will open or close hydraulic communication between the outlet ports 62 and the tank ports 63, 64, as generally known to the skilled person.

Turning to the braking function which can be performed by pump kit 100, 200, the output from the pressure sensor will be read by a controller, which pressure sensor and output port 62 are in fluid communication with solenoid valve 5. Solenoid valve port 5 is also in fluid communication with tank ports 63, 64, which are attached to the fluid reservoir containing the hydraulic fluid/oil.

When a user wants to release the corresponding brake, the controller will be instructed to cause current to be applied to motor 1 and solenoid valve 5. Solenoid valve 5 then closes the path from the brake outlet ports 62 to the tank ports 63, 64. Motor 1 then urges actuator shaft 17 to rotate. Since actuator shaft 17 is threaded into piston 15 via threading 61, turning the threading 61 (i.e., screw) urges piston 15 to rotate. As previously described, with the at least partially spherical shape of anti-rotation plug 4 or ball 59 in the slot 58 of piston 15, piston 15 is prevented from rotating.

Since piston 15 cannot rotate, the rotating actuator shaft 17 urges piston 15 instead to move to the right due to the threaded connection between actuator shaft 17 and piston 15. Since there will be sufficient oil in the fluid cavity 50, moving the piston 15 to the right causes oil from the fluid cavity 50 to be displaced, thereby causing flow of the oil. The displaced oil from piston 15 is therefore pushed into the brake line through the selected outlet port 62. Said another way, the pressure cavity 50 and the selected outlet port 62 are in hydraulic connection with both the pressure sensor and the corresponding SAHR (spring applied-hydraulically released) brake via the brake line. The SAHR brake can be any suitable SAHR brake, and it may be a SAHR caliper, a multi-disc SAHR brake, or other SAHR brake configuration.

Since the corresponding SAHR brake will be a dead head on the brake line, pressure builds in the brake line. Sufficient buildup of pressure thereby causes the SAHR brake to release. At a first predetermined pressure, which may be referred to as a maximum release pressure, the controller, which senses pressure via the pressure sensor, should cut power to motor 1 while continuing to maintain current in the solenoid valve. This will keep pressure in the brake line and will keep the SAHR brake released. This is the normal driving condition.

In the event pressure leaks below the maximum release pressure within the brake line, then at another predetermined pressure, which may be referred to as a minimum release pressure, the controller should turn motor 1 back on to reestablish maximum release pressure in the brake line as described above. By maintaining release pressure in a range between the minimum and maximum release pressure, it can be assured that the corresponding SAHR brake will remain properly and fully released during driving without concern for over-pressurization, which could cause possible mechanical damage, or under-pressurization, which could cause brake drag, heat, and wear.

When commanded either by the operator or by predetermined conditions, the controller should engage the corresponding brake for parking or emergency stopping. This can be accomplished by cutting power to the solenoid valve 5, which is normally open. This opens the fluid communication between the brake line via the selected outlet port 62 and the selected tank port 63, 64. With that fluid communication established, pressure in the brake line will be released to the tank (i.e., at atmospheric pressure). This will drop the brake line pressure to zero, which will cause the corresponding brake to engage.

The controller can then reverse the current on motor 1, which would urge actuator shaft 17 to the reverse direction. This would cause piston 15 to return to the ‘original’ position at the left-hand end (relative to FIG. 3) of the piston bore. When the piston 15 makes contact with housing 18, the current in motor 1 will rise dramatically and the controller will sense this rise in current. This rise in current will serve as a signal to the controller that the piston 15 is fully retracted, and the controller will shut off the current to motor 1. The pump kit 100, 200 will then be reset to restart at this point whenever the operator commands for the restart. This resetting procedure can be done as soon as the brake is engaged or could be programmed to be performed at a later time, such as being the first step in releasing the brake later. As an additional note, when piston 15 reverses direction, this will cause a suction that will draw fluid from the reservoir back into the pressure chamber 50. Thus, the pressure chamber 50 will always remain full of oil regardless of the position of piston 15 position.

Since piston 15 making contact with housing 18 will tend to result in a sudden stop, the potential for very high forces and damage is present. To alleviate this problem, steel ball 13 and rubber washer 12 are positioned between hex socket plug 11 and actuator shaft 17. Before piston 15 makes contact with housing 18, steel ball 13 will hit the right side nose of actuator shaft 17. Rubber washer 12 acts as a spring element, though less stiff, so that the ramp up on force is much less sharp. This effect is akin to an ‘air bag’ effect. The controller has time to sense this rise in current before forces become extreme, in order to shut off current to the motor. This dampens the forces generated compared to the absence of steel ball 13 and rubber washer 12.

Other spring element solutions could be employed to assist with dampening the forces. A compression spring or a disc spring could be placed under hex socket plug 11 to perform a similar function. A polyurethane plug, which can have spring-like features, could be used in place of steel ball 13 and rubber washer 12. Also, the spring element could be employed in housing 18, such as being within the counterbore on the right hand side of housing 18. A compression spring or a disc spring or even a polyurethane plug acting as a spring could be positioned in this bore, and it would hit the face of piston 15, before piston 15 makes contact with housing 18.

There is also a potential concern with damage due to slight pressure leaks. In this regard, the volumetric displacement of the pump kit 100, 200 is dependent upon the diameter and stroke of piston 15. In a typical application, the SAHR brake's volumetric requirement for full release might be no more than approximately 75% of the volume of pump kit 100, 200. This leaves some room for error and leaves space in the event of small system leaks. If any component of the pressurized brake system leaks, pressure will drop. At the minimum release pressure, the controller will turn on motor 1 to cause piston 15 to displace more fluid, increasing pressure, until the maximum release pressure is again reached. If the leak is more substantial, the unit will cycle repeatedly, and piston 15 will gradually move closer and closer to the bottom of the pressure cavity 50. If piston 15 hits the bottom of the cavity 50, current draw will rise dramatically. The controller will sense this sudden rise in current, and shut off the current. The controller might also be configured to warn the operator, either visually or audibly, that the brake is not fully released. Or power to the solenoid valve 5 might be cut followed by resetting pump kit 100, 200.

Regardless of which actions above the controller might take, there is again potential for damage if piston 15 hits bottom suddenly, since all the parts are relatively stiff. To alleviate this concern, disc spring 9 is positioned in the bottom of the bore between piston 15 and manifold 6. The shoulder on piston 15 is intended to hit disc spring 9 before hex socket plug 11 would hit the bottom of the counterbore in manifold 6. This disc spring 9 serves to provide an ‘air bag’ feature via a spring element, so that current draw and forces rise more gradually.

As mentioned above, the operation of pump kit 100, 200 for causing the corresponding brake to release includes building pressure in the corresponding brake line. Efforts may be taken to protect the brake line and/or the pump kit 100, 200 from over-pressurization. Too high of pressures can result in damage to one or more of the brake, brake line, and pump kit. One technique for assisting with preventing overpressure would be to use the solenoid valve 5 itself to relieve excess pressure. With the solenoid valve 5 being of a direct acting type, the solenoid valve 5 could protect the system. If the controller or other external means limits the current of the solenoid valve 5, then the force which can be developed by the solenoid valve 5 is also limited. At relatively higher pressure, the force generated by the brake line pressure could exceed the force of the coil of the solenoid valve 5. This would cause the solenoid valve 5 to ‘crack open’ until the pressure is relieved enough to cause the solenoid valve 5 to reclose. This technique should include ensuring the solenoid valve 5 would operate in this manner over a large range of temperatures.

Another technique for assisting with preventing overpressure would be employing a relief valve, such as a thermal relief valve. Thermal relief valves are generally designed to relieve pressure at very small flow. The relief valve could be placed on the corresponding brake line, along with the pressure sensor, and would crack open a path between the brake line and tank at a preset pressure. An exemplary opening pressure for a relief valve is about 2,200 psi and an exemplary closing pressure for a relief valve is about 1,900 psi.

A further technique for assisting with preventing overpressure would be to rely on a particular operation of the motor assembly 1. If the pressure sensor is a pressure transducer and not a simple pressure switch, then the controller could detect a high-pressure condition. The controller can then send a pulse of known current to the motor 1 to reverse the motor 1. The pulse would likely be very short (e.g., on the order of milliseconds) and the motor 1 could repeatedly pulse until the over-pressurization condition is corrected. A similar technique could include the controller sending very short pulses to the motor on a timed schedule (i.e., instead of sensing and reading the high pressure continuously). For instance, at a particular interval (e.g., about three minutes, about five minutes, or other suitable time) the controller could send a pulse for slightly reversing the motor 1. In this scenario, the interval pulse would be a normal operation. Occasionally, the interval pulse would cause the pressure sensor to notify the controller that pressure is too low, which would cause the motor 1 to kick on in the forward direction to reset pressure. Any use of this technique should be considered relative to the potential to cause slow and gradual motion of the piston 15 towards the bottom of the bore. If the piston 15 were to hit the bottom of the bore, pressure would fall, and the corresponding brake would engage, thereby requiring the pump kit 100, 200 to be reset.

In view of the above, the pump kit 100, 200 may be referred to as a single piston, single stroke, reciprocating pump. While not shown in the Figures, the pump kit 100, 200 may be positioned within an enclosure for additional protection of the pump kit 100, 200 when utilized with a vehicle. As mentioned above, the pump kit 100, 200 may be particularly suitable for use with a spring applied-hydraulically released brake. The end application may be a vehicle which is used above ground or below ground. Exemplary end application vehicles include on-highway vehicles and pickup trucks converted for low speed, off-highway use, golf carts, utility vehicles, utility vehicles converted for open pit mining, and other high-slope, off-highway applications. As suggested above, the end application will generally include a vehicle with no existing hydraulic system from the factory.

It is thus evident that a pump kit constructed and operated as described herein accomplishes the objects of the present invention and otherwise substantially improves the art.

What is claimed is:

1. A pump kit for a spring applied hydraulic release brake, the pump kit comprising
a motor assembly including a first spline as an output, the first spline being coupled with a second spline of an actuator shaft;
the actuator shaft including an extension with male threading threaded with an inner female threading of a piston within a through hole of the piston; and
the piston including an external slot with a component having an at least partial curved surface sitting therein, the component having the at least partial curved surface also being partly positioned within a hole within an outside of a housing;
where the slot, the component having the at least partial curved surface, and the hole in the housing are configured to prevent the piston from rotating in an operational configuration, such that the operational configuration instead includes the piston moving toward a fluid cavity within the housing.

2. The pump kit of claim 1, where the first spline of the motor assembly is a male spline, and where the second spline of the actuator shaft is a female spline.

3. The pump kit of claim 2, further comprising a retaining ring holding the female spline of the actuator shaft onto the male spline of the motor to prevent the female spline and the male spline from decoupling.

4. The pump kit of claim 1, where the housing contains the piston and at least a portion of the actuator shaft.

5. The pump kit of claim 1, further comprising a second housing sandwiched between the piston and an end plate, the end plate being sandwiched between the second housing and the motor assembly.

6. The pump kit of claim 5, the end plate including a radial outward extension with respective ends which contact the motor assembly and the housing.

7. The pump kit of claim 6, the end plate being secured with the motor assembly and the housing via fasteners positioned through the radial outward extension.

8. The pump kit of claim 5, an inner portion of the end plate serving as a reaction surface for a combination of a pair of washers and a needle thrust bearing.

9. The pump kit of claim 8, the actuator shaft including a flange, where the combination of the pair of thrust washers and the needle thrust bearing are positioned between the flange and the inner portion of the end plate.

10. The pump kit of claim 1, the through hole of the piston including a steel ball positioned near an end of the actuator shaft, the steel ball adapted to act on a rubber washer positioned between the steel ball and a hex socket plug which seals the through hole of the piston.

11. The pump kit of claim 1, an end of the housing being contained within and secured within a manifold, the manifold including tank ports and outlet ports in fluid communication with a solenoid valve.

12. The pump kit of claim 1, where the male threading of the extension of the actuator shaft and the inner female threading of the piston are partial threading relative to respective lengths of the extension and the piston.

13. The pump kit of claim 1, further comprising a spring retainer and a compression spring to maintain position of the retaining ring, the spring retainer including a counterbore receiving the retaining ring therein, the compression spring maintaining constant contact of the spring retainer with the retaining ring.

14. The pump kit of claim 1, where the component having the at least partial curved surface is a ball.

15. The pump kit of claim 1, where the component having the at least partial curved surface is an anti-rotation plug including a nose formed in a partial spherical shape.

16. A method of controlling brake line pressure via a pump kit, the method comprising steps of
instructing, via a controller, a current to be applied to a motor and a solenoid valve to thereby close a path between brake outlet ports of the pump kit and tank ports of the pump kit;
allowing the motor to urge an actuator shaft to turn, where the actuator shaft is threaded into a piston, where the piston includes a slot with a component having an at least partial curved surface sitting therein, with the component having the at least partial curved surface also being partly positioned within a hole within an outside of a housing of the pump kit; and
urging the piston to move toward a fluid cavity within the housing based on the slot, the component having the at least partial spherical surface, and the hole in the housing being configured to prevent the piston from rotating in an operational configuration.

17. The method of claim 16, an end of the housing being contained within and secured within a manifold, the manifold including tank ports and outlet ports in fluid communication with a solenoid valve, further comprising a step of allowing pressure to build within the fluid cavity and a corresponding brake line of a corresponding brake via connection of the corresponding brake line with a selected one of the outlet ports.

18. The method of claim 17, the step of allowing pressure to build occurring up to a sufficient buildup of pressure to cause the corresponding brake to release from a braking function.

19. The method of claim 18, further comprising a step of instructing, via the controller, to cut power to the motor while maintaining current in the solenoid valve, which thereby maintains pressure in the corresponding brake line while keeping the corresponding brake released from the braking function.

20. The method of claim 19, further comprising steps of
instructing, via the controller, to restore power to the motor to thereby increase pressure in the corresponding brake line;
releasing the pressure in the corresponding brake line to atmospheric pressure, thereby causing the corresponding brake to engage in the braking function; and
instructing, via the controller, to reverse the current applied to the motor, thereby urging the actuator shaft to a reverse direction, thereby resetting the pump kit to an original position.
